(19) United States
(12) Patent Application Publication
(10) Pub. No.: US 2014/0249919 A1
(43) Pub. Date: Sep. 4, 2014

(54) SYSTEM FOR GENERATING REVENUE FROM MOBILE SOCIAL NETWORKING

(71) Applicant: Louis Alvin Lippincott, Los Altos, CA (US)

(72) Inventor: Louis Alvin Lippincott, Los Altos, CA (US)

(21) Appl. No.: 14/143,470

(22) Filed: Dec. 30, 2013

Related U.S. Application Data
(60) Provisional application No. 61/848,375, filed on Jan. 2, 2013.

(51) Int. Cl. G06Q 50/00; G06Q 30/02

(52) U.S. Cl. CPC G06Q 50/01; G06Q 30/0255; G06Q 30/0267
USPC 705/14.53

(57) ABSTRACT

A system and method for improved advertising revenue streams for social networking service providers via automatic exchange of information shared by individuals on social networking service providers and/or their mobile computing devices, wherein said exchanged information contains implied or explicit advertisements is disclosed.

### CROSS-REFERENCE TO RELATED APPLICATIONS

This application claims the benefit of and priority to the following U.S. Provisional Patent Application No. 61/848,375 filed Jan. 2, 2013 which is incorporated herein by reference in its entirety.

### TECHNICAL FIELD OF THE INVENTION

The invention relates generally to social networking and mobile computing devices and specifically to automatic exchange of information shared by individuals on social networking service providers and/or their mobile computing devices. Additionally, the invention describes and enables improved advertising revenue streams for social networking service providers.

### BACKGROUND OF THE INVENTION

Most people do their social networking at home or their workplace where they have access to a computer and the Internet. There, they update their social information based on the activities in their life, people they've interacted with, events they've attended, etc. Social networking services have capitalized on the mass appeal of social networking by presenting advertisements on each individual's space in the social networking cyberspace. In addition, social media marketing programs attempt to create content that appeals to certain individuals which encourages them to share it with their friends and family. The shared content is usually well received because it is coming from a trusted person and it has the sender's implied approval or recommendation. Therefore, shared advertisements, whether they are obvious advertisements or not, have a higher value to the suppliers of the products or services than do advertisements that are broadly presented by the suppliers themselves.

When outside of the home or workplace, most people's social media interactions are reduced to text messages and phone calls. These interactions are initiated by one person and usually are targeted to another single individual or a predetermined group of individuals. Often an individual will use a social networking service such as Twitter to indicate they are going to lunch now (or whatever activity they are about to do), but that message will only be received by people that have already asked to receive those messages from that individual. In other words, they already know that individual. Essentially no one will send a text message or call a person they are unfamiliar with, even if they happen to be sharing the same elevator with someone who works in the same building who is also on their way to lunch.

Consider a hypothetical case of several people taking an elevator down to the street level in a busy commercial high-rise. Two of the people sharing the elevator, one male and one female, have much more in common than either one realizes. His name is Joe and her name is Jane.

Unknown to the other person, each one is hungry and going to lunch. (Neither one was on the other's Twitter feed because they do not know each other.) The Italian restaurant around the corner is on each person's top five local places to each lunch. Joe and Jane are both single and not currently in a serious relationship. Each person enjoys cross country skiing, hiking, swimming and bicycling as hobbies. Each person prefers a getaway to the mountains in the winter, (and it happens to be winter). They both live in the city where they work. Jane lives only a few blocks from Joe. Joe owns two cats and Jane adores cats, but can't have one in her apartment. Jane's last vacation was to Tahoe and Joe has always wanted to go to Tahoe. Joe is going cross country skiing this coming weekend and Jane has no plans for the weekend. Joe likes a certain kind of beer with lunch and Jane prefers a glass of red wine with lunch. Jane works at a law firm on the 12^{th} floor and Joe works for a real estate development company on the 8th floor. Both Joe and Jane have jobs that keep them very busy and only occasionally eat lunch out of the building.

The elevator reaches the ground floor and the crowd of people exit out into the busy lobby of the building. Even though Jane and Joe are physically attractive to each other, neither one takes their interactions with the other further than nodding and saying hi. After all, neither one knows that the other is available and looking to be in a serious relationship. They go to lunch at different restaurants and don't share the same elevator until several months later. It turns out that Jane and Joe never end up trying out a relationship with each other.

Clearly, Joe and Jane could have enjoyed lunch together. They had a lot they could have talked about. Joe may have invited Jane to go with him on his planned cross country ski trip the coming weekend. However, because they did not share personal information, such as the personal information contained on their social media page, with each other that they would willingly have shared in a more private setting, none of those things happened.

Thus, there is a need in the art for methods, systems, and apparatuses that provide an environment in which some personal information can readily and privately be shared with other individuals. Ideally, the infrastructure and technology costs to provide the new capabilities are funded from increased advertising revenue. The invention described below solves problems in the hypothetical case for Joe and Jane and for the real world and also allows for a source of revenue for social media service providers, such as Facebook and Google.

### BRIEF SUMMARY OF THE INVENTION

The invention allows for a background exchange of information between mobile computing devices. Preferably, the exchange of information is done wirelessly via Bluetooth, but the invention would also work via Wi-Fi or another standardized wireless transmission method. Triggers, i.e. interest-threshold levels, notify the user when they are near a person who has shared information that matches criteria they have previously determined. The triggers keep the user from being inundated with information about people they happen to be near or pass by. When the user sets up their triggers they are given choices they have to make between preferred products and services. These choices are, in actuality, advertisements to the user that will also be passed along to people they share their social media information with.

According to a first aspect, a system for sharing preselected information wirelessly between mobile computing devices, comparing such information received against a predetermined set of criteria and notifying the user via a vibratory and/or audible signal from the mobile computing device when the criteria has been met.

According to a second aspect, a system for sharing preselected information wirelessly between mobile computing devices, comparing such information received against a predetermined set of criteria and notifying the user via a visual indication and/or audible signal from a set of augmented reality glasses that provides a wearable display for the user.

According to a third aspect, the information received, plus additional information that may be pulled from a social media network, can be viewed by the user on their mobile computing device.

According to a fourth aspect, the shared information, plus additional information that may be pulled from a social media network, viewed by the user on their mobile computing device is partially determined by the user's physical location.

According to a fifth aspect, the method of preselecting the information to be shared includes presenting a set of choices to the user that include specific product brands and/or specific service providers and/or advertisements and/or promotions. Said choices made by the user are part of the shared information exchange.

According to a sixth aspect, the method of preselecting the trigger events includes placing levels of importance on matches to choices made by the user.

According to a seventh aspect, the method of obtaining information about another individual is based on facial recognition by a set of augmented reality glasses that provides a wearable display for the user. The gathering of information is performed via a social networking service and done without an exchange of information with the other individual's mobile computing device.

### BRIEF DESCRIPTION OF THE DRAWINGS

FIG. 1 illustrates two people holding mobile computing devices exchanging information.

FIG. 2 illustrates an example of the presentation of shared information.

FIG. 3 illustrates an example of a menu of choices used in the setup of information to be shared.

FIG. 4 illustrates an example of a menu of choices used in the setup of trigger events.

FIG. 5 illustrates a simplified flow chart of the decision process by the mobile computing device on whether or not to notify the user of a trigger event.

### DETAILED DESCRIPTION

Methods, apparatuses, and systems for sharing preselected information with individuals in close proximity while mobile are described. In the following description, numerous specific details are set forth. However, it is understood that embodiments may be practiced without these specific details. In other instances, well-known circuits, structures, and techniques have not been shown in detail in order not to obscure the understanding of this description.

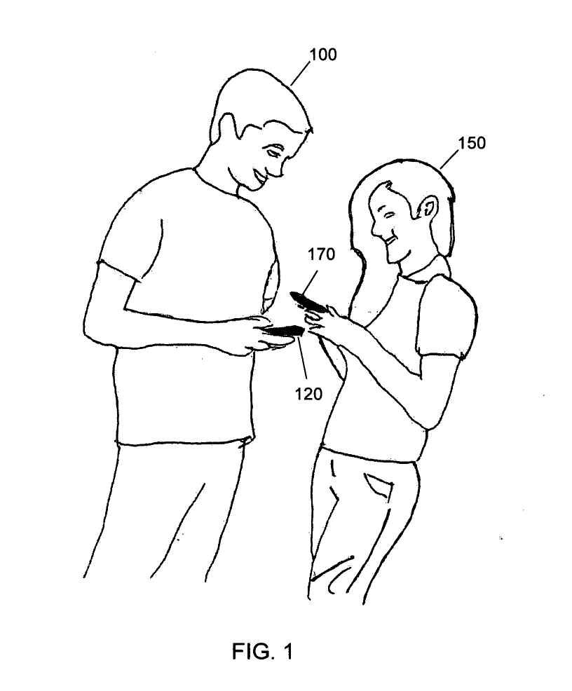

FIG. 1 illustrates a male 100 and a female 150 reviewing exchanged information on their mobile computing devices 120 and 170 respectively. For purposes of illustration, the male 100 in FIG. 1 is Joe and the female 150 is Jane, described in the hypothetical case in the BACKGROUND OF THE INVENTION section above. In the preferred embodiment of the invention, the exchange of information occurred in the background, perhaps while Joe 100 and Jane 150 were walking towards each other. In the preferred embodiment of the invention, the exchange of information was transmitted and received to and from the mobile computing devices via a wireless communications means such as Bluetooth as soon as the two mobile computing devices came within range of the communications means, which in the case of Bluetooth, is currently about 30 feet. The invention description will not go into detail about the workings of Bluetooth as it is a standardized, well documented and understood communications means. Anyone skilled in the art will know how to establish a connection between two devices that support the Bluetooth standard.

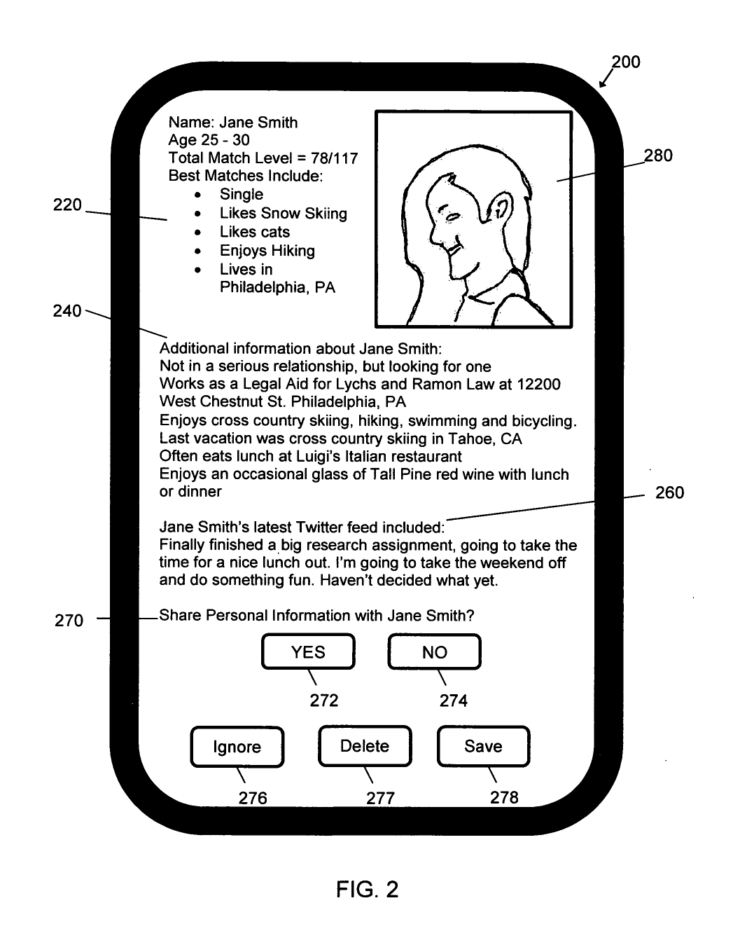

FIG. 2 illustrates an example of the information that would be shared by Jane's mobile computing device 170 and transmitted to Joe's mobile computing device 120. Joe's mobile computing device 120 vibrated and/or emitted an audible tone when the trigger event occurred. Joe pulled the mobile computing device from his pocket and looked at the mobile computing device's screen 200. Some of the information shown on the mobile computing device's screen 200 may have been pulled from the Internet on a social networking service once Jane had been identified and a trigger event occurred. A picture of Jane 280 is displayed. This allows Joe to easily identify Jane as they approach each other. Some or all of the information that caused the trigger event is displayed 220 to the left of Jane's picture 280. The trigger information immediately tells Joe that Jane's full name is Jane Smith, she is 27 years old, there was a good match to Joe's trigger criteria (78 out of 100), she is single, likes snow skiing, cats and hiking and lives in the same city as Joe. In another embodiment of the invention, the mobile computing device's screen display is a set of augmented reality glasses.

In the preferred embodiment of the invention, the trigger event criteria and trigger information was stored locally on the mobile computing devices. The local storage of information needed to make a trigger event decision allows for an immediate exchange of information without having the mobile computing devices connect to the Internet and gather the required information. Once a trigger event has occurred, then the mobile computing devices can take the additional step of connecting to the Internet to gather additional information about the other person. Said additional information would be displayed on screen 200 as shown 240. The additional information 240 about Jane tells Joe that she is not in a serious relationship, but trying to find the right person, she is a Legal Aid at law firm in the same building he works in, she enjoys a lot of the same activities he enjoys and her last vacation was in Tahoe, Calif. Although he may not realize it, Joe has also been exposed to two sets of advertisements. In the preferred embodiment of the invention, the suggestion that Jane likes to eat at Luigi's Italian Restaurant is actually a choice Jane made from a set of five or so restaurant choices presented to her when she set up her own trigger event criteria and/or set up her own profile. The owner of Luigi's paid the social networking service provider for the opportunity to be one of the choices for people in the Luigi's Italian Restaurant area when asked to select one of the five local places where they would choose to have lunch or dinner. If Joe asks Jane to join him for lunch, he is more likely to ask her if she would like to eat at Luigi's with her implied approval or recommendation of Luigi's than if he would be if he did not have that implied approval or recommendation. Therefore, as described earlier, the advertisement presented to both Jane and Joe in this situation has value to the owner of Luigi's Italian Restaurant. The same is true for the implied approval or recommendation of Tall Pine wines. In the preferred embodiment of the invention, the suggestion that Jane likes Tall Pine red wine with lunch is also a choice Jane made when setting up her own trigger event criteria and/or setting up her own profile. Having been exposed to the ad for Tall Pine wine, Joe is more likely to ask Jane if she would like a glass of Tall Pine red wine during lunch at Luigi's. It doesn't really matter too much if Luigi's carries Tall Pine winery wines or not. If enough people ask for it at Luigi's, then Luigi's will eventually succumb to the demand and start serving Tall Pine wines.

In the preferred embodiment of the invention, there are a number of security levels assigned to different types of information. The user can identify which levels of information can be shared automatically and which levels of information need approval before being shared. Facebook for example, has levels of information a user will share only if you are a “friend” while anyone can see other, less personal, information. In the preferred embodiment of the invention, the levels of information shared can be automatically adjusted according to the Total Match Level of the trigger event shown in the trigger event information 220. In this example, Joe may want to automatically share the equivalent information as a Facebook “friend” because Jane had a very high Total Match Level of seventy eight. In other words, Joe automatically “friends” Jane because of the good match to his important criteria. Another level of information shared may be the user's Twitter feed. If Jane allows her Twitter feed to be given to Joe then he may see information such as shown 260 on screen 200 in FIG. 2. This additional information tells Joe that Jane is free this weekend and gives him the choice of mentioning his ski trip this coming weekend if they connect well at lunch. Another possibility may be the automatic establishment of a connection in another social media networking service such as Linked In.

The manual control of information exchange for certain levels may take the form of a question 270 as shown on screen 200 in FIG. 2. This level of information may contain personal information such as addresses and phone numbers. When the user is asked if they would like to share personal information 270 the user could select a button labeled Yes 272 or No 274 to control the security level for the exchange of information with this person.

In the preferred embodiment of the invention, there are methods of manually setting the status of someone with whom you have gathered information about. The methods might include options in the form of selections made available when viewing the information gathered from another individual, such as the options shown as the choices to Ignore 276 this person, Delete 277 them from your list of interesting people or Save 278 them in your preferred list of interesting people. In another embodiment of the invention, one could simply drag the other person's image to an icon to perform a function, such as dragging their picture to a trashcan icon to delete them from your list of interesting people, or a file cabinet icon to save them in your list of interesting people.

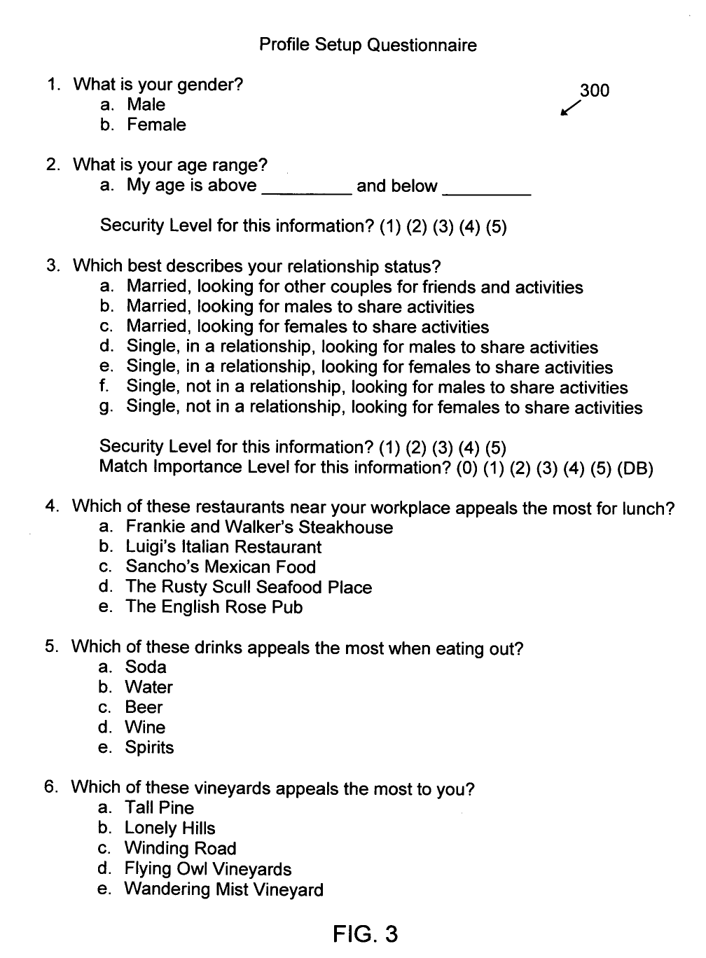

In the preferred embodiment of the invention, there is a process the user goes through to compile information about them. In the preferred embodiment of the invention, this process includes giving the user additional choices that are actually advertisements for products and/or services that may be shared with other individuals. In an embodiment of the invention, the user would be led through a menu of choices, such as the ones shown on FIG. 3, Profile Setup Questionnaire 300. FIG. 3 shows six questions as a sampling of representations used to illustrate the invention and do not necessarily represent actual questions that would be on the Profile Setup Questionnaire. In an embodiment of the invention, the user would be led through a menu of choices one at a time and not as a full screen of choices as shown in FIG. 3. FIG. 3 shows six questions simply to illustrate the invention and to provide material for the discussion about several of the different types of questions that may be presented to the user.

Question 1 in FIG. 3 illustrates one of the simplest types of question that would be asked. The user is either (a) Male or (b) Female. In an embodiment of the invention, there is no control for the security level of this type of obvious information. This type of information is always shared with other mobile devices that are enabled with the technology of the invention, unless they have been purposely blocked by the other person's mobile device or it has been previously determined by the user to not share any information with the other person's mobile device. There is further discussion on the process of ignoring people later in this document.

Question 2 in FIG. 3 illustrates a type of question that has a security level associated with it. In an embodiment of the invention, a security level of (1) may mean the information is always shared, (2) may mean the information is shared only if a good match is found. In other words, the Total Match Level is above a predetermined level. A security level of (3) may mean the information is shared only if a better match is found. In other words, the Total Match Level is above a higher predetermined level compared with level (2). This may be the equivalent of “friending” someone on Facebook. A security level of (4) may mean the information is shared only if the user gives explicit approval through a manual process, such as a positive response to a prompt to do so as shown as button 272 in FIG. 2. A security level of (5) may mean the information is never shared via the invention.

Question 3 in FIG. 3 illustrates a type of question that has a Match Importance Level associated with it, since there is an implied preference embedded in the choices given for the question. There is also a security level associated with question 3, which has already been described for the question 2 example above. In the preferred embodiment of the invention, the Match Importance Levels indicate different weights given to matches with similar data received from another person via their mobile device and/or via a social networking service. A higher weight given to a match means a higher importance of the match to the user, perhaps to the level where a mismatch is a “deal breaker.” Conversely, a lower weight given to a match means a lower importance of the match to the user, perhaps to a level where it does not matter at all. In an embodiment of the invention, a Match Importance Level of (0) means a match with similar data from another individual with the user's data does not matter at all. A Match Importance Level of (1) means a match with similar data from another individual with the user's data carries some weight. A Match Importance Level of (2) means a match with similar data from another individual with the user's data carries more weight than level (1). A Match Importance Level of (3) means a match with similar data from another individual with the user's data carries more weight than level (2). A Match Importance Level of (4) means a match with similar data from another individual with the user's data carries more weight than level (3). A Match Importance Level of (5) means a match with similar data from another individual with the user's data carries more weight than level (4). A Match Importance Level of (DB) means a match with similar data from another individual with the user's data carries enough weight to be a deal breaker. In other words, the user would like to ignore people (not get the audible and/or visual indication of a match from the invention) unless the similar data provided by another individual matched the user's criteria. For example, if the user selected (g) Single, not in a relationship, looking for females to share activities in question 3 and a Match Importance Level of (DB), then the invention would ignore any individual who was not a female.

Question 4 in FIG. 3 illustrates a type of question that has an advertisement embedded in it. The owners of each of the restaurants listed would have paid a small fee for the privilege of being on the list of selections for question 4. Note how the question is worded such that there has to be one selection made. The selection made by the user will be sent as part of their shared data as an implied recommendation or approval for that particular restaurant. In the preferred embodiment of the invention, there are different fee levels for the embedded advertisements. In an embodiment of the invention, an additional fee is paid for the advertisement when a user selects their particular selection. In other words, when Jane (in the example discussed) selected (b) Luigi's Italian Restaurant for question 4, the owner of Luigi's Italian Restaurant would pay an additional fee for being part of the data that gets shared with other individuals. In an embodiment of the invention, an additional fee is paid each time the data about Luigi's Italian Restaurant is shared with another individual. In an embodiment of the invention, a further additional fee is paid each time the data about Luigi's Italian Restaurant is shared with another individual and a coupon for Luigi's Italian Restaurant is presented on the receiving individual's mobile computing device. In an embodiment of the invention, an even further additional fee is paid each time the data about Luigi's Italian Restaurant is shared with another individual and a coupon for Luigi's Italian Restaurant is presented on the receiving individual's mobile computing device and the coupon is redeemed. In this example, Luigi's Italian Restaurant is being used generically to represent any buyer of advertising used by the invention.

Question 4 in FIG. 3 illustrates a type of question that also has a geographical position embedded in it. In the preferred embodiment of the invention, the words “near your workplace”, as an example, have special meaning in the invention. Other questions in the Profile Setup Questionnaire 300 would have allowed the invention to determine the geographical position of the user's workplace, home, gym where he/she works out, etc. In the preferred embodiment of the invention, the geographical position of the user at the time data is shared with an individual is used to determine which data is shared, including which advertisements to share. In the preferred embodiment of the invention, the time of day when the data is shared with an individual is also used to determine which data is shared, including which advertisements to share. Knowing the location and time of day allows the invention to better select advertisements to share. For example, around 12 noon, near work, it's better to share data about where you like to eat lunch on a lunch break from work, contrasted with sharing data about restaurants where you like to eat dinner around where you live.

Question 5 in FIG. 3 illustrates a type of question that determines the form of the next question. For example, Question 6 would be about brands of wine only if the user selected (d) Wine for the answer to Question 5. Otherwise, Question 6 would take a different form.

Question 6 in FIG. 3 is another example of embedded advertising. In an embodiment of the invention, pictorial representations of products and/or services, in this example, wine bottle labels, would be presented to the user to help form a user preference when the user has no experience with any of the choices offered to them.

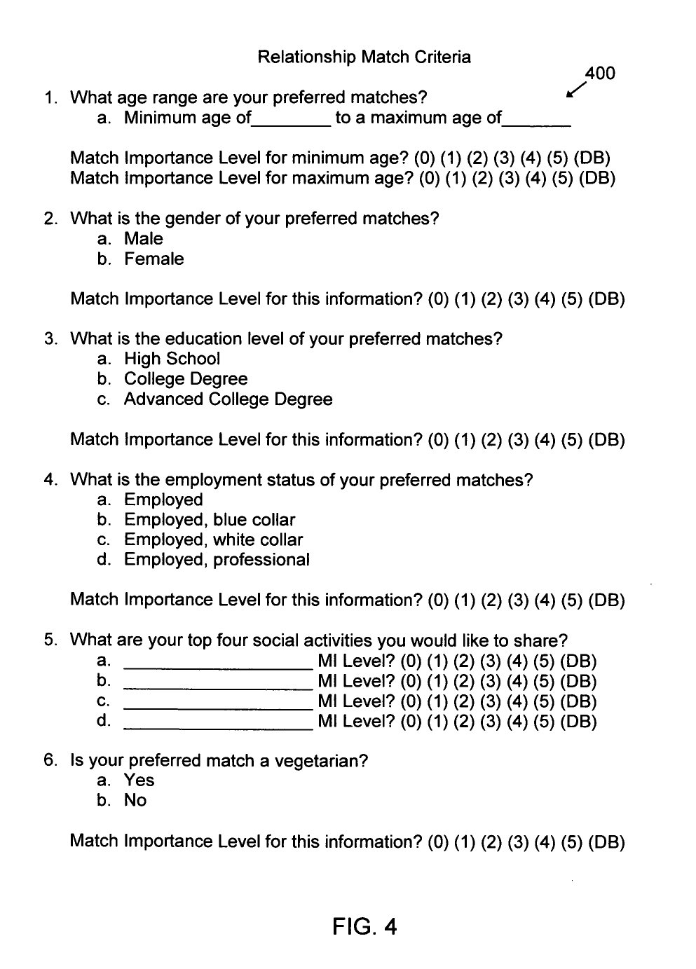

In the preferred embodiment of the invention, there is a process the user goes through to compile information about what makes people interesting to them. In other words, what kind of characteristics they want to have their mobile computing device look for in people they come close to. These trigger event criteria, when met, will cause their mobile computing device to notify them of a match. In the preferred embodiment of the invention, the process of setting up the trigger event criteria includes giving the user additional choices that are actually advertisements for products and/or services that may be shared with other individuals. In an embodiment of the invention, the user would be led through a menu of choices, such as the ones shown in FIG. 4, Relationship Match Criteria 400. FIG. 4 shows six questions as a sampling of representations used to illustrate the invention and do not necessarily represent actual questions that would be in the Relationship Match Criteria setup process. In an embodiment of the invention, the user would be led through a menu of choices one at a time and not as a full screen of choices as shown in FIG. 4. FIG. 4 shows six questions simply to illustrate the invention and to provide material for the discussion about several of the different types of questions that may be presented to the user.

In the preferred embodiment of the invention, the user can save the results of a completed trigger event setup as a specific trigger event profile. In the preferred embodiment of the invention, these saved profiles can be turned on and off by the user as his/her situation changes while they are mobile. For example, a man may have a “girlfriend” trigger set up and a “golf buddy” trigger set up. The two trigger events would likely have very different trigger event profiles. He may want to golf only with other guys around his age, while he may prefer to find a girlfriend who likes to go dancing. The two trigger event profiles could be active at the same time or enabled independently at different times. For example, he may want to disable his girlfriend trigger event profile while working out at the gym and keep his golf buddy trigger event profile active. In an embodiment of the invention, the user can have many trigger event profiles saved and any number of them active at a time.

In the preferred embodiment of the invention, some of the saved trigger event profiles could be marked as dynamic profiles. Dynamic trigger event profiles would update their match criteria as the world around them changes. One example would be a trigger event profile the user sets up to help find someone who would like to see a movie. After setting up the typical preference criteria for a match the user can tag the trigger event profile as dynamic and ask to get updates when new movies are released. In an embodiment of the invention, the key word “movie” could be used by the invention to guide the user through a specific menu of questions about seeing movies. Some of these prompts could be embedded advertisements for specific movies and movie theaters, as well as coupons for popcorn, etc. As new movies are released the system would prompt the user for input on what new movies he or she would like to see. For example, their mobile computing device might ask: “Cloud Atlas is getting good reviews. It's a movie about past lives and karma, starring Tom Hanks and Halle Berry. Would you like to see this movie? Would you like to see a trailer for this movie?” An affirmative answer by the user would update the saved profile to include “Wants to see Cloud Atlas” in the match criteria and could present the next show times and theaters around where he is when a match is found.

Question 1 in FIG. 4 illustrates a type of question that has a two Match Importance Levels associated with it, since there are actually two answers embedded in the choice given for the question, i.e. minimum age and maximum age. A Match Importance Level of (1) means a match with similar data from another individual with the user's data carries some weight. A Match Importance Level of (2) means a match with similar data from another individual with the user's data carries more weight than level (1). A Match Importance Level of (3) means a match with similar data from another individual with the user's data carries more weight than level (2). A Match Importance Level of (4) means a match with similar data from another individual with the user's data carries more weight than level (3). A Match Importance Level of (5) means a match with similar data from another individual with the user's data carries more weight than level (4). A Match Importance Level of (DB) means a match with similar data from another individual with the user's data carries enough weight to be a deal breaker. In other words, the user would like to ignore people (not get the audible and/or visual indication of a match from the invention) unless the similar data provided by another individual matched the user's criteria. For example, if the user entered 18 for the minimum age and a Match Importance Level of (DB), then the invention would ignore any individual who was not 18 years old or over.

Question 2 in FIG. 4 illustrates one of the simplest types of question that would be asked. The user is either looking for (a) Male or (b) Female, or he/she doesn't care. If the user doesn't care then he could select either male or female and assign it a Match Importance Level of (0).

Question 3 in FIG. 4 illustrates a question that may have several answers that could be selected. In the preferred embodiment of the invention, the process of setting up the trigger event criteria would allow for multiple answers for some types of questions and will be able to discern the real intent for the user. For example, let's assume the user selected (DB) for the Match Importance Level meaning it's a deal breaker if another individual doesn't match the criteria. If just (a) is selected, it would mean that the user does not want to meet someone who is college educated, but has graduated from High School. If just (b) and (c) are selected then it means the user wants to meet someone who is college educated. If (a) and (b) and (c) are selected then the user wants to meet someone with at least a High School education. The corresponding question in the Profile Setup Questionnaire (300) that would apply to Question 3 in FIG. 4 may be something like: What is the highest level of education that you have achieved?, with the same choices as given to Question 3 in FIG. 4.

Question 4 in FIG. 4 illustrates another question that may have several answers that could be selected.

Question 5 in FIG. 4 illustrates a question that has key words as answers. In the preferred embodiment of the invention, the process of setting up the trigger event criteria would take key words and assign them specific values or characteristic descriptors. For example, the words “cooking” and “preparing meals” and “baking” for an activity with a high Match Importance Level (MI Level) may all be assigned the same Match Code value (described in detail later) meaning the same activity, i.e. the person I′m looking for should like to cook. For another example, the words “hiking” and “taking long walks” and “walks in the woods” for an activity with a high Match Importance Level (MI Level) may all be assigned the same Match Code value meaning the same activity, i.e. the person I′m looking for should like to walk outdoors.

Question 6 in FIG. 4 illustrates another one of the simplest types of question that would be asked. The user is either looking for (a) Vegetarian or (b) a non-vegetarian, or he/she doesn't care, i.e. a Match Importance Level of (0).

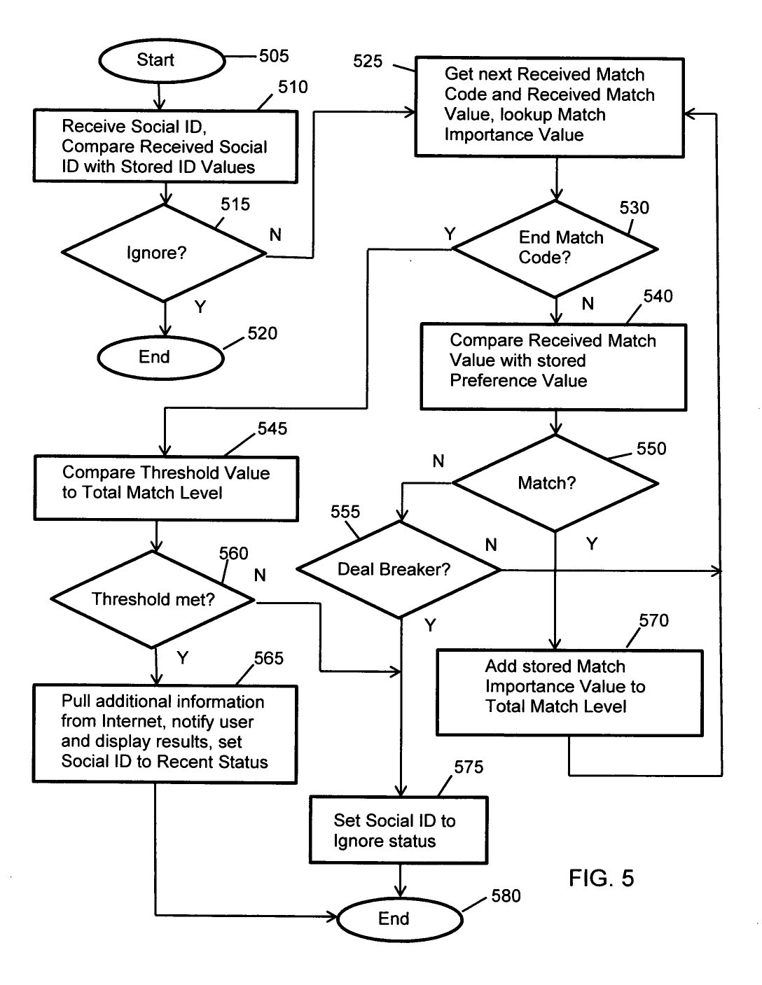

FIG. 5 illustrates a simplified flow chart of the decision process by the mobile computing device on whether or not to notify the user of a trigger event. As mentioned earlier, the reader should understand that the process of establishing a wireless connection with another device is beyond the scope of the description for the invention and such processes are well understood by those skilled in the art. In the preferred embodiment of the invention, the wireless connection with another device is established via the Bluetooth communications standard.

In an embodiment of the invention, a wireless connection is made between the user's mobile computing device and a number of mobile computing devices within range of the user's mobile computing device. For purposes of clarity in the discussion, we will assume that a connection is made with the user's mobile computing device and one other mobile computing device. Before entering into the flow chart process in FIG. 5 at the Start point 505, the user's Social ID has been sent to the other mobile device. Around the same time, the other connected mobile device is sending their Social ID. In addition, around the same time, the user's Match Codes and Match Values are being sent to the other connected mobile device and the other connected mobile device is sending their Match Codes and Match Values to the user's mobile computing device.

Entering the Start of the process 505, the first steps are taken in block 505, where the user's device gets the Received Social ID and compares it with a corresponding Stored ID Value for that Received Social ID stored on the user's mobile computing device, if there is one. In an embodiment of the invention, a user's Social ID is given to them by a social networking service, such as Facebook. In another embodiment of the invention, a user's Social ID is simply their mobile phone number. If there is no Stored ID Value or the Stored ID Value is still at its default status for the Received Social ID, then the process will continue. Otherwise, if there is a Stored ID Value and the Stored ID Value indicates that this mobile computing device should be ignored, then the process will end and no trigger event will occur. A Received Social ID will have a corresponding Stored ID Value set to Ignore status for at least one of several reasons. If the Received Social ID is from a mobile computing device that was recently reviewed, caused a trigger event and was accepted by the user, it should be ignored for a while in order to keep from constantly notifying the user of a match from the same mobile computing device. If the Received Social ID is from a mobile computing device that was recently reviewed, caused a trigger event and was rejected by the user, it should be ignored for a very long while in order to keep from notifying the user of a match from the same mobile computing device when he is likely not interested in reviewing its owner again. If the Received Social ID is from a mobile computing device that was recently reviewed, but did not cause a trigger event, it should be ignored for a long while in order to save power and compute time. In the preferred embodiment of the invention, just how long a person will be ignored for each particular reason can be determined by the user. For example, a person the user is very interested in may only be ignored for an hour or two in order to get that person's latest Twitter feed data or latest Facebook update the next time they pass by each other. The decision to ignore the person, i.e. their mobile computing device, is made in decision block 515 in FIG. 5. If the person is ignored the process ends at the End position 520 and goes back to looking for a new Received Social ID from a different mobile computing device.

In the preferred embodiment of the invention, a separate list of wireless devices that have had recent connections established is maintained and used to decide at the wireless communications level on whether or not to establish a connection. This capability can keep the user's mobile device from establishing connections over and over in a setting where the user remains in close proximity with another mobile computing device, such as while eating dinner in a restaurant.

If the decision made in block 515 in FIG. 5 indicated the person should not be ignored then the flow will go to block 525 where the mobile computing device will get the next Received Match Code and Received Match Value sent from the other person's mobile computing device and lookup its own Match Importance Value for that particular Received Match Code. In block 530 the Received Match Code is tested to see if the code is an End Match Code, which would signify an end to the Received Match Code and Received Match Value data that was sent by the other person's mobile computing device. If the Received Match Code is not an End Match Code, then the flow would continue to block 540 where the Received Match Value is compared with the user's own locally stored Preference Value. In block 550 it is determined if the Received Match Value matches the user's own locally stored Preference Value. If there is a match then the flow continues to block 570 where the user's own locally stored Match Importance Value for that particular Received Match Code is added to a running total match value called Total Match Level. The process would then continue by returning to block 525 again to check the next Received Match Code and Received Match Value sent from the other person's mobile computing device. If the step in block 550 determines the Received Match Value does not match the user's own locally stored Preference Value then a further check is made in block 555 to see if this mismatch is a deal breaker or not. If the mismatch is not a deal breaker then the process would continue by returning to block 525 again to check the next Received Match Code and Received Match Value sent from the other person's mobile computing device.

If the mismatch is a deal breaker then the flow would continue to step in block 575 where the Social ID received would be set to the Ignore status and then the process would end at the End state 580 where it would wait for another wireless connection to be established before starting the process over in the Start state 505.

The process of moving through blocks 525, 530, 540, 550 and then either 555 or 570 would continue until an End Match Code is found in block 530. At this point the flow would move over to block 545 where the running total held in the Total Match Level is compared with the Threshold Value set by the user. If the threshold was not met, i.e. the other person does not have enough in common with the user's preferences for this particular trigger event profile, the flow continues as if a mismatch was found and it was a deal breaker by going to block 575 as described earlier. If the threshold was met, i.e. the other person does have enough in common with the user's preferences for this particular trigger event profile, the flow continues with block 565 where additional information is pulled by the user's mobile computing device, compiled with the match data already found, the results displayed and the user notified.

In the preferred embodiment of the invention, the match data already found, the additional information pulled by the user's mobile computing device and the results displayed can be filtered and/or modified based on the geographical location of the user.

In the preferred embodiment of the invention, the user is notified via a vibratory and/or audible signal from their mobile computing device.

In an embodiment of the invention, notifying the user is performed via a visual indication and/or audible signal from a set of augmented reality glasses that provides a wearable display for the user.

The Social ID received would be set to the Recent status, which would prevent the user's mobile computing device from repeating the same match for a predetermined amount of time. The process would end at the End state 580 where it would wait for another wireless connection to be established before starting the process over in the Start state 505. If there are multiple trigger event profiles stored on the user's mobile computing device, the same Received Match Codes and Received Match Values would be used for each additional trigger event profile by repeating the process outlined in FIG. 5 before trying to establish another wireless connection with a different mobile computing device.

In an embodiment of the invention, the additional data pulled by the user's mobile computing device is a combination of data stored locally on the other person's mobile computing device and data that is found on the Internet such as information about the other person found through a social networking service.

In an embodiment of the invention, the data received from the other person's mobile computing device could be a string of characters or values such as the string: Social ID, Match Code, Match Value, . . . Match Code, Match Value, End Match Code. The string would contain some number of Match Codes and Match Values depending on how much match data the other person wants to share, i.e. their Security Levels for the data. The Match Codes and Match Values could be unique numerical values for each specific personal preference or characteristic. For example, the value 0001 could mean the gender of the individual and a corresponding Match Value of 01 could mean male and 02 could mean female. If the other person's mobile computing device sent a Match Code of 0001 followed by a Match Value of 02 it would mean the other person is a female. If the user's corresponding Preference Value for a Match Code of 0001 was 02 (the user prefers a female in this trigger event profile) then the user's corresponding Match Importance Value for a Match Code of 0001 is added to the running total for the match. If the user's corresponding Match Importance Value for a Match Code of 0001 was 04, then 04 is added to the running total for the match. If the user's corresponding Match Importance Value for a Match Code of 0001 was a deal breaker, then the highest value allowed is added to the running total for the match. Keeping a running total by adding in the Match Importance Values allows the more important matches to carry more weight for the match. For example, a match where the Match Importance Value is 05 carries more weight than four matches where the Match Importance Values each have a weight of 01.

In the preferred embodiment of the invention, the highest possible score for the Match Importance Values is computed to provide a gauge for the user on setting a threshold for a match.

In the preferred embodiment of the invention, each person involved in the exchange of information has at least a portion of the invention embodied in their mobile computing device. In an embodiment of the invention, only the user has at least a portion of the invention embodied in their mobile computing device. For example the user may be wearing a set of augmented reality glasses with a camera that can facilitate facial recognition. In this example only data about that person that is found via the Internet such as information found through a social networking service is gathered. In another example, the user asks someone for their Social ID and manually enters it into his mobile computing device. Again, in this example only data about that person that is found via the Internet such as information found through a social networking service is gathered.

In the preferred embodiment of the invention, profile setup questionnaires used to create trigger event profiles are transmitted to the user's mobile computing device. The profile setup questionnaires can originate from the Internet via social networking services, for example, or they can originate locally via a wireless connection. Locally originated profile setup questionnaires are useful for very localized applications. For example, a user may enter a mall and immediately have a profile setup questionnaire about shopping transmitted to his mobile computing device. The user could then easily setup a trigger event profile to identify his/her needs. For example, a man may be shopping for a gift for his 12 year old nephew. Filling out a short profile setup questionnaire would allow stores he passes by to cause a trigger event if the store (having an embodiment of the invention) offers products appropriate for 12 year old boys. The trigger events and the associated match data could include advertisements, coupons, price reductions, etc. presented to the user. In another example, a user may enter a home products store, such as The Home Depot, and immediately have a profile setup questionnaire about home products shopping transmitted to his mobile computing device. The user could then easily setup a trigger event profile to identify his/her needs. For example, a woman may be shopping for caulk to fix a leaking window. Filling out a short profile setup questionnaire would allow The Home Depot (having an embodiment of the invention) to cause a trigger event notifying the user of the aisle where caulk could be found. The trigger events and the associated match data could include advertisements, coupons, price reductions, etc. and helpful installation information presented to the user.

In view of the wide variety of permutations to the embodiments described herein, this detailed description is intended to be illustrative only, and should not be taken as limiting the scope of the invention. To illustrate, while operations have been described with reference to mobile computing devices, embodiments are not so limited. For example, in an embodiment, the functionality of a mobile computing device can be embodied in a set of augmented reality glasses. Moreover, while described with reference to the finding of likeminded people, embodiments are not so limited. For example, in one embodiment, the invention can be used in a business setting to automatically identify who is attending a meeting and what the status of their project is at the moment. Therefore, the specification and drawings are to be regarded in an illustrative rather than a restrictive sense.

I claim:

1. A system and method for sharing preselected information wirelessly between mobile computing devices comprising:
transmitting a first user's preselected information from said first user's mobile computing device to a second user's mobile computing device;
receiving information to said first user's mobile computing device from said second user's mobile computing device;
comparing said information received against a predetermined set of criteria, wherein said set of criteria has been previously determined by said first user completing a questionnaire determining said first user's interests, wherein said questionnaire includes choices for specific products and/or services;
notifying said first user via a visual indication and/or audible signal from the mobile computing device when said predetermined set of criteria has been met;
and transmitting said choices for specific products and/or services to said second user's mobile computing device as implied or explicit endorsements from said first user for said products and/or services.

2. The system and method of claim 1, wherein said questionnaire includes match importance levels indicating the first user's level of importance for specific match criteria.

3. The system and method of claim 1, wherein said shared information includes additional information from a social media networking provider.

4. The system and method of claim 1, wherein said shared information includes implied or explicit endorsements from said first user that are at least partially determined by the first user's physical location.

5. A system and method for gathering preselected information wirelessly in a set of augmented reality glasses that provides a wearable display for the first user comprising:
facial recognition by said set of augmented reality glasses;
receiving information from a second user's social networking provider, wherein said second user is identified by said facial recognition;
said second user completing a questionnaire determining said second user's interests, wherein said questionnaire includes choices for specific products and/or services;
comparing said second user's information received against a predetermined set of criteria, wherein said set of criteria has been previously determined by said first user completing a questionnaire determining said first user's interests;
notifying said first user via a visual indication and/or audible signal from the set of augmented reality glasses when said predetermined set of criteria has been met;
and receiving said choices for specific products and/or services to said first user's set of augmented reality glasses as implied or explicit endorsements from said second user for said products and/or services.

6. The system and method of claim 5, wherein said gathered information includes information at least partially determined by said first user's physical location.

7. The system and method of claim 5, wherein said gathered information includes information at least partially determined by the time of day.

8. A system and method for sharing preselected information wirelessly between a mobile computing device and a stationary computing device comprising:
transmitting a first user's preselected information from said mobile computing device to said stationary computing device;
receiving information to said mobile computing device from said stationary computing device;
comparing said information received to said mobile computing device from said stationary computing device against a predetermined set of criteria, wherein said set of criteria has been previously determined by said first user completing a questionnaire determining said first user's product and/or service needs;
and notifying said first user via a visual indication and/or audible signal from the mobile computing device when said predetermined set of criteria has been met.

9. The system and method of claim 8, wherein said stationary computing device is located in a store providing products and/or services.

10. The system and method of claim 8, wherein said stationary computing device is located in a store providing products and/or services, wherein said received information to said mobile computing device from said stationary computing device includes coupons and/or promotions for products and/or services provided by said store.
